(19) United States
(12) Patent Application Publication
(10) Pub. No.: US 2014/0220222 A1
(43) Pub. Date: Aug. 7, 2014

(54) METHOD FOR PRODUCING ALCOHOL-FREE BEER-TASTE SPARKLING BEVERAGE HAVING FRUITY AROMA IMPARTED THERETO WITH REDUCED OFF FLAVOR

(71) Applicants: Atsushi Murakami, Chuo-ku (JP); Yoshimi Oku, Chuo-ku (JP); Yukimasa Owa, Chuo-ku (JP); Yumiko Kawasaki, Chuo-ku (JP)

(72) Inventors: Atsushi Murakami, Chuo-ku (JP); Yoshimi Oku, Chuo-ku (JP); Yukimasa Owa, Chuo-ku (JP); Yumiko Kawasaki, Chuo-ku (JP)

(73) Assignee: KIRIN BEER KABUSHIKI KAISHA, Chuo-ku, Tokyo (JP)

(21) Appl. No.: 14/239,490

(22) PCT Filed: Aug. 13, 2012
(86) PCT No.: PCT/JP2012/005129

§ 371 Date: Feb. 18, 2014

(30) Foreign Application Priority Data
Aug. 22, 2011 (JP) 2011-180607
Aug. 22, 2011 (JP) 2011-180608

(51) Int. Cl. A23L 2/56; A23L 2/38

(52) U.S. Cl. CPC A23L 2/56; A23L 2/38
USPC 426/598

(57) ABSTRACT

An object of the present invention is to provide a method for producing an alcohol-free beer-taste sparkling beverage imparted with a fruity aroma and a reduced off-flavor; and an alcohol-free beer-taste sparkling beverage imparted with a fruity aroma and a reduced off-flavor produced by the aforesaid production method. “The method for producing an alcohol-free beer-taste sparkling beverage imparted with a fruity aroma and a reduced off-flavor” in the present invention is characterized by use of a hop or a hop component stored and aged in the state of being in contact with air as a hop or a hop component used during a raw material liquid-boiling step, or adjustment of the contents of myrcene, linalool, and nerol in the beer-taste sparkling beverage so as to satisfy five particular numerical ranges by boiling the hop or the hop component in a raw material liquid.

### TECHNICAL FIELD

The present invention relates to a method for producing an alcohol-free beer-taste sparkling beverage imparted with a fruity aroma and a reduced off-flavor; and an alcohol-free beer-taste sparkling beverage imparted with a fruity aroma and a reduced off-flavor produced by the aforesaid production method.

### BACKGROUND ART

As for the conventional low-alcoholic sparkling malt beverages, the flavor has been brought close to the beer taste by performing fermentation with yeast, as in usual beer beverages, whereas beverages with a reduced alcohol content have been commonly produced by using a single or a plurality of methods such as suppression of fermentation or removal of alcohol after fermentation (see for example, patent document 1). That is, in production of any of the conventional low-alcoholic sparkling malt beverages, it has been common to perform fermentation with yeast.

In the case of a production method accompanied by fermentation, if the amount of alcohol to be formed is suppressed by performing strict control, the extent of suppression is limited, and it has been difficult to achieve an alcohol content of 0.00% (W/W). Thus, fermentation with yeast was eliminated, and a wort formed from malt with a hop aroma added thereto was used as the final product to achieve a sparkling malt beverage with an alcohol content of 0.00% (w/w).

A hop or the like is known to impart a refreshing bitter taste and flavor to fermented alcoholic malt beverages such as beer. A flavor derived from the hop or the like exerts a great influence on character formation of beers. Terms to describe the characteristics of the aroma derive from the hop or the like, such as floral, spicy, citrus, fruity, hoppy, and muscat are commonly used (hereinafter, non-patent documents 1 to 5). However, each of these was aroma characteristics after fermentation with yeast, and was not sensory evaluation for non-fermented beverages.

Alternatively, it has been conventionally known that control of storage conditions of hops and enhancement of chemical changes such as oxidization of hop components are effective for improvement in the aroma components and modification of the bitter taste characteristics of hops (patent documents 2 to 4). In patent document 2, for example, it takes 12 to 40 days at 30° C. and 8 to 30 days at 40° C. to obtain a bitter taste of the desired quality. However, beverages in patent documents 2 to 4 are beer-based beverages obtained by alcoholic fermentation with yeast. In non-fermented beer-taste sparkling beverages without alcoholic fermentation, such as alcohol-free beer-taste sparkling beverages according to the present invention, it has not been known which hop aroma of a non-fermented beer-taste sparkling beverage is obtained depending on storage and aging conditions of hops used.

### PRIOR ART DOCUMENTS

### Patent Documents

Patent Document 1: Japanese unexamined Patent Application Publication No. 05-068528
Patent Document 2: Japanese unexamined Patent Application Publication No. 2008-212041
Patent Document 3: Japanese unexamined Patent Application Publication No. 2007-89439
Patent Document 4: Japanese unexamined Patent Application Publication No. 2008-228634

### Non-Patent Documents

Non-patent Document 1: Comparison of the Odor-Active Compounds in Unhopped Beer and Beers Hopped with Different Hop Varieties; TORU KISHIMOTO, AKIRA WANIKAWA, KATSUNORI KONO, AND KAZUNORI SHIBATA; J. Agric. Food Chem., 54, 8855-8861 8855, 2006
Non-patent Document 2: Comparison of Odor-Active Compounds in the Spicy Fraction of Hop (Humulus lupulus L.) Essential Oil from Four Different Varieties; GRAHAM T. EYRES, PHILIP J. MARRIOTT, AND JEAN-PIERRE DUFOUR; J. Agric. Food Chem., 55, 6252-6261, 2007
Non-patent Document 3: Hop Aroma in American Beer; Val E. Peacock, Max L. Deinzer, Lois A. McGill, and Ronald E. Wrolstad; J. Agric. Food Chem., 28, 774-777, 1980
Non-patent Document 4: Aging of Hops and Their Contribution to Beer Flavor; Kai C. Lam, Robert T. Foster 11, and Max L. Deinzer; J. Agric. Food Chem., 34, 763-770 763, 1986
Non-patent Documents 5: Floral Hop Aroma in Beer; Val E. Peacock, Max L. Deinzer, Sam T. Likens, Gail B. Nickerson, and Lois A. McGill; J. Agric. Food Chem., 29, 1265-1269, 1981

### SUMMARY OF THE INVENTION

### Object to be Solved by the Invention

The object of the present invention is to provide a method for producing an alcohol-free beer-taste sparkling beverage imparted with a fruity aroma and a reduced off-flavor; and an alcohol-free beer-taste sparkling beverage imparted with a fruity aroma and a reduced off-flavor produced by the aforesaid production method.

### Means to Solve the Object

The present inventors attempted to impart a fruity aroma using a hop to a beer-taste sparkling beverage having an alcohol content of 0.00% (w/w) using a non-fermented wort, but, as a result, an alcohol-free sparkling beverage far from the beer taste was obtained. That is, resin-like or oil-like off-flavors of the hop manifested itself, and it was not possible to feel a fruity aroma from the beverage.

In the case of using a hop in beer-based beverages subjected to alcoholic fermentation, a portion of a hop aroma component during alcoholic fermentation tends to change to thereby moderate the hop aroma. However, in the case of using a hop in non-fermented beer-taste sparkling beverages not subjected to alcoholic fermentation, the aroma of the hop tends to directly manifest itself, and thus, the hop aroma was potentially influenced more sensitively depending on the storage and aging conditions of the hop than that in the case of using the hop in beer-based beverages.

As a result of reviewing the storage and aging conditions of hops in detail to reduce the previously-described off-flavor and make adjustment into a more preferable taste, the present inventors have found that it is possible to impart a fruity aroma derived from a hop with a reduced off-flavor derived from the hop (particularly, a resin-like odor) when the hop stored and aged in the state of being in contact with air, preferably, a hop stored and aged such that the storage temperature (° C.) and the storage period (days) satisfy a particular relational equation, and in addition, preferably, a hop in which the myrcene content is less than a particular numeric value are used, thereby completing a first present invention.

Additionally, as a result of carefully choosing hops from among a large number of varieties and considering the method for using the hops in detail to reduce this off-flavor and to make adjustment into a more preferable taste, the present inventors have found that it is possible to impart a fruity aroma derived from the hops with a reduced off-flavor (particularly, a resin-like odor) derived from the hops when the values quantified by gas chromatography/mass spectrometry (hereinafter, also represented by “GC/MS”) of particular aroma components derived from the hops satisfy particular five numerical ranges, thereby completing a second present invention.

That is, the present invention relates to:

(1) a method for producing an alcohol-free beer-taste sparkling beverage imparted with a fruity aroma and a reduced off-flavor, the method comprising the following step (X) or step (Y):
step (X): in a method for producing an alcohol-free beer-taste sparkling beverage using a hop or a hop component, a step of using a hop or a hop component stored and aged being in contact with air, as a hop or a hop component used during a raw material liquid-boiling step:
step (Y): in production of an alcohol-free beer-taste sparkling beverage using a hop or a hop component, a step of adjusting a content of myrcene, linalool, and nerol in the beverage to satisfy the following numerical ranges (a) to (e) of values quantified by GC/MS by boiling the hop or the hop component in a raw material liquid:
(a) when an internal standard substance borneol is added so as to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration higher than 0.4 ppb, and
(d) a ratio of a value (%) of the ratio in (a) to a value (ppb) of the linalool concentration being 5.2661 or less, and
(e) a ratio of the value (%) of the ratio in (a) to a value (ppb) of the nerol concentration being 59.7692 or less;
(2) the method for producing a beer-taste sparkling beverage according to the (1), wherein the content of myrcene in the hop or the hop component is adjusted to satisfy a range of the following values quantified by GC/MS, by storing and aging of the hop or the hop component used during the raw material liquid-boiling step of the step (X) being in contact with air:
when an internal standard substance naphthalene is added in a hop or hop component sample to reach 2.5 ppm, a ratio of a response value of an ion 93 m/z of myrcene to a response value of an ion 128 m/z of the internal standard substance naphthalene being less than 756.9% in the hop or hop component sample;
(3) the method for producing a beer-taste sparkling beverage according to the (1) or (2), wherein a variety of the hop in the hop or the hop component used in the raw material liquid-boiling step of the step (X) is a Motueka, and a storage temperature (° C.) and a storage period (days) in the storage and aging of the hop and the hop component are adjusted to satisfy the following numerical range:

63.616×[storage temperature (° C.)]+115.700×[storage period (days)]>2487;

(4) the method for producing a beer-taste sparkling beverage according to the (2) or (3), wherein a boiling time of the hop or the hop component in the step (Y) is within a range of 5 minutes to 20 minutes;
(5) the method for producing a beer-taste sparkling beverage according to any one of the (1), (2) and (4), wherein the hop or the hop component is a hop or a hop component of Motueka;
(6) an alcohol-free beer-taste sparkling beverage imparted with a fruity aroma and a reduced off-flavor produced by the method for producing a beer-taste sparkling beverage according to any one of the (1) to (5); and
(7) an alcohol-free beer-taste sparkling beverage imparted with a fruity aroma and a reduced off-flavor, wherein, in the alcohol-free beer-taste sparkling beverage using a hop or a hop component, a content of myrcene, linalool, and nerol in the beverage are prepared to satisfy the numerical ranges (a) to (e) of values quantified by GC/MS:
(a) when an internal standard substance borneol is added to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration being higher than 0.4 ppb, and
(d) a ratio of a value (%) of the ratio in the (a) to a value (ppb) of the linalool concentration being 5.2661 or less, and
(e) a ratio of the value (%) of the ratio in the (a) to a value (ppb) of the nerol concentration being 59.7692 or less.

### Effect of the Invention

According to the present invention, it is possible to provide a method for producing an alcohol-free beer-taste sparkling beverage imparted with a fruity aroma derived from a hop or a hop component and a reduced off-flavor derived from the hop or the hop component; and an alcohol-free beer-taste sparkling beverage imparted with a fruity aroma and a reduced off-flavor, produced by the aforesaid production method. The aforesaid fruity aroma is one that is not found in the conventional alcohol-free beer-taste sparkling beverages.

### BRIEF DESCRIPTION OF DRAWINGS

FIG. 1 is a diagram showing the relationship between the degree of storage and aging of a hop and the myrcene content (%).

### MODE OF CARRYING OUT THE INVENTION

A. “A Method for Producing an Alcohol-Free Beer-Taste Sparkling Beverage Imparted with a Fruity Aroma and a Reduced Off-Flavor” in the Present Invention

In the present invention, “a method for producing an alcohol-free beer-taste sparkling beverage imparted with a fruity aroma and a reduced off-flavor” is characterized by having the following step (X) or step (Y). It should be noted that the production method having the above-described step (X) is “the method for producing an alcohol-free beer-taste sparkling beverage imparted with a fruity aroma and a reduced off-flavor” relating to the first present invention (hereinafter, referred to merely as “the production method of the first present invention”), and the production method having the above-described step (Y) is “the method for producing an alcohol-free beer-taste sparkling beverage imparted with a fruity aroma and a reduced off-flavor” relating to the second present invention (hereinafter, referred to merely as “the production method of the second present invention”):

step (X): in a method for producing an alcohol-free beer-taste sparkling beverage using a hop or a hop component, a step of using a hop or a hop component stored and aged being in contact with air as a hop or a hop component used during a raw material liquid-boiling step:
step (Y): in production of an alcohol-free beer-taste sparkling beverage using a hop or a hop component, a step of adjusting a content of myrcene, linalool, and nerol in the beverage to satisfy the following numerical ranges (a) to (e) of values quantified by GC/MS by boiling the hop or the hop component in a raw material liquid:
(a) when an internal standard substance borneol is added to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration being higher than 0.4 ppb, and
(d) a ratio of a value (%) of the ratio in (a) to a value (ppb) of the linalool concentration being 5.2661 or less, and
(e) a ratio of the value (%) of the ratio in (a) to a value (ppb) of the nerol concentration being 59.7692 or less.

A-1. Production Method of the First Present Invention

The production method of the first present invention is characterized by use of a hop or a hop component stored and aged being in contact with air (hereinafter, also referred to merely as “hop or the like in the first present invention”) as the hop or the hop component used during the raw material liquid-boiling step, in production of an alcohol-free beer-taste sparkling beverage using a hop or a hop component (hereinafter, referred to collectively as “a hop or the like”).

Although the detailed mechanism is not known, when a hop or the like stored and aged being in contact with air and preferably a hop or the like stored and aged at the predetermined storage temperature for the predetermined storage period are used as a hop or the like used during the raw material liquid-boiling step, it is possible to produce an alcohol-free beer-taste sparkling beverage imparted with a fruity aroma derived from the hop or the like and a reduced off-flavor derived from the hop or the like. Conventionally, adjustment of an aroma derived from a hop is generally performed by adjusting the timing and amount of addition of the hop to the raw material liquid and confirming that the desired aroma is obtained on each occasion of production. According to a method for adjusting a hop or the like per se such that the desired aroma is liable to be obtained, as the present invention, it is possible to produce beverages having the desired aroma very efficiently and additionally to reduce variations in the aroma between products.

“The alcohol-free beer-taste sparkling beverage imparted with a fruity aroma and a reduced off-flavor” in the first present invention means an alcohol-free beer-taste sparkling beverage imparted with a fruity aroma derived from a hop or the like and a reduced off-flavor and of which off-flavor derived from the hop or the like (suitably a resin-like odor, an oil-like odor, more suitably a resin-like odor) is not so strong as to suppress the previously-described fruity aroma. Above all, in the case where intensities of the fruity aroma and the resin-like odor are each represented by a five-grade score (1: “do not feel,” 2: “feel slightly,” 3: “feel,” 4: “feel a little intensely,” 5: “feel intensely”), an example of the beverage may suitably include an alcohol-free beer-taste sparkling beverage, in which the intensity score of the fruity aroma is 2 or more (preferably 3 or more, more preferably 4 or more), in which the intensity score of the resin-like odor is 4 or less (preferably 3 or less, more preferably 2 or less), and in which the intensity score of the resin-like odor does not exceed the intensity score of the fruity aroma.

An example of the “fruity aroma” in the first present invention is not particularly limited as long as the aroma is a fruity aroma derived from a hop or the like, and may suitably include a refreshing and lush fruity aroma, and above all, may more suitably include a muscat-like aroma. It should be noted that the presence or absence and extent of aromas such as these fruity aromas and odors such as an off-flavor can be evaluated using sensory evaluation by panelists. Above all, an example of the sensory evaluation may suitably include sensory evaluation using a score in which the intensities of aromas and odors are represented in five grades, as shown in Example 2 described below. It should be noted that “alcohol-free” herein means that no alcoholic content is contained.

A “hop or a hop component stored and aged being in contact with air” in the first present invention mean a hop or a hop component aged by being stored being in contact with air for a certain period. The hop or the like is usually sealed not so as to contact oxygen for prevention of their deterioration due to excess oxidation. However, by storing a hop or the like being in contact with air for a certain period, moderate oxidation is caused to thereby provide a hop or the like suitable for the method of the present invention. Therefore, as long as such a hop or the like can be obtained, the above-described “air” is not limited to the air in a strict sense. Although the “air” in the present invention includes oxygen-containing gases, for convenience, in a point that contact may be easily made by just opening the sealed package of a hop or the like, an example of the air may suitably include the air in a strict sense, that is, “gases constituting the troposphere of the earth's atmosphere.”

In a beer-taste sparkling beverage to be produced, from the viewpoint of imparting a larger amount of a fruity aroma derived from a hop or the like as well as more reducing an off-flavor derived from the hop or the like, examples of the above-described “hop or a hop component stored and aged being in contact with air” in the production method of the first present invention may suitably include a hop or the like stored and aged at a storage temperature (° C.) for a storage period (days) being in contact with air so as to satisfy a mathematical equation:

63.616×[storage temperature (° C.)]+115.700×[storage period (days)]>2487.

Above all, an example of the hop or the like may more suitably include a hop or the like stored and aged at a storage temperature (° C.) for a storage period (days) so as to satisfy a mathematical equation:

63.616×[storage temperature (° C.)]+115.700×[storage period (days)]≧2660.

Above all, an example of the hop or the like may particularly suitably include a hop or the like stored and aged at a storage temperature (° C.) for a storage period (days) so as to satisfy a mathematical equation:

3239≧63.616×[storage temperature (° C.)]+115.700×[storage period (days)]≧2660.

More specifically, an example of the hop or the like may suitably include a hop or the like stored and aged at 20° C. for more than 5 days to 12 days or less, at 30° C. for more than 5 days to 11 days or less, or at 40° C. for 4 days or more to 6 days or less. It should be noted that the storage temperatures and storage periods listed above are particularly suitably applied when the variety of the hop in the hop or the like is Motueka. Alternatively, the above-described “storage period (days)” may not be necessarily a positive integer and may be a numeric value including the decimal point.

Other examples suitable as the above-described “hop or a hop component stored and aged being in contact with air” include a hop or a hop component in which the myrcene content is adjusted to satisfy the range of the following values quantified by gas chromatography/mass spectrometry (hereinafter, also referred to as “GC/MS”) by being stored and aged being in contact with air. It is preferred that the myrcene content satisfy the following ranges of the quantified values, in a respect that the intensity of a resin-like odor can be more reduced.

When an internal standard substance naphthalene is added in a hop or hop component sample so as to reach 2.5 ppm, the ratio of the response value of an ion 93 m/z of myrcene to the response value of an ion 128 m/z of the internal standard substance naphthalene is less than 756.9% in the hop or hop component sample (preferably 414.1% or less, more preferably 414.1% or less and 26.2% or more).

An example of the method for regulating the myrcene content (%) in a hop or the like to the aforesaid range may suitably include a method for subjecting a hop to storage and aging at a storage temperature (° C.) for a storage period (days) that satisfy the mathematical equations listed above. It should be noted that the suitable range of the previously-described myrcene content (%) can be particularly suitably applied when the variety of the hop in the hop or the like is Motueka.

As GC/MS, commercially available apparatuses can be used without problems. Additionally, as a method for analysis and measurement by GC/MS, the known methods for analysis and measurement by GC/MS can be used. Above all, an example of the method may suitably include a method for analysis and measurement using Naphthalene as the internal standard substance, and above all, may more suitably include a method for preparing hop samples and a method for analysis and measurement by GC/MS specifically described in Example 1 described below.

The production method of the first present invention is not particularly different from the conventional production method of an alcohol-free beer-taste sparkling beverage using a hop or the like, except that the hop or the like in the first present invention is used as a hop or the like used during the raw material liquid-boiling step. It is possible to extract a hop or the like with a raw material liquid containing a part or all of the raw materials other than hop-derived components, among the raw materials of the aforesaid beer-taste sparkling beverage. An example of the raw material liquid may suitably include a wort containing malt, but the liquid may be a raw material liquid containing no malt (for example, a raw material liquid containing malt extract).

The type of the hop in the hop or the like used in the first present invention is not particularly limited as long as the hop or the like may be used for production of a beer-taste sparkling beverage of the first present invention. Examples of the hop or the like, above all, may more suitably include Motueka hop and Cascade hop, above all, may further suitably include Motueka hop from the viewpoint of obtaining a more suitable fruity aroma, and above all, may particularly suitably include Motueka hop produced in New Zealand. The hop or the like used in the production method of the first present invention may be one variety, or may be two varieties or more. It should be noted that the above-described hop component means an aroma component derived from the hop, and examples of the aforesaid hop component may suitably include hop extract and hop essential oil.

In the production method of the first present invention, the timing to add the hop or the like in the first present invention to the raw material liquid is not particularly limited as long as the aroma components of the aforesaid hop or the like are eluted into the raw material liquid. Examples of the timing may suitably include addition to the raw material liquid during boiling or at the completion of boiling, from the viewpoint of obtaining a suitable fruity aroma. It should be noted that, in the first present invention, any conditions for extracting a hop or the like may be used without particular limitation, as long as the conditions are equivalent to those in the case where the hop or the like is boiled in the raw material liquid to thereby extract a hop component or in the case where the hop or the like is added at the completion of boiling of the raw material liquid to thereby extract a hop component. For example, it is possible to employ methods for boiling and extracting a hop or the like separately from the raw material liquid and mixing the boiled product or extract with the raw material liquid.

In the beer-taste sparkling beverage produced according to the production method of the first present invention, whether a fruity aroma is imparted thereto with a reduced off-flavor in fact may be confirmed by performing sensory evaluation on a beer-taste sparkling beverage produced in plant scale. However, performing sensory evaluation on tasting samples prepared as follows is preferred from the viewpoint of simplicity.

[Preparation of Tasting Samples in the First Present Invention]

Tasting samples in the first present invention can be prepared using a 1.5 L scale apparatus. First, a feed wort with a sugar content of the feed wort adjusted to 1.0 degree (the ratio of malt used at feeding: 67% and the ratio of auxiliary materials used (rice, corn grits, and corn starch): 33%) can be provided as a sample wort. This sample wort can be heated and boiled with an electronic heater. At this time, boiling can be controlled such that the boiling intensity is constant and that the evaporation ratio reaches 10% in 60 minutes. When boiling of the sample wort is finished, 2.5 g/L of each of the hop or the like in the present invention can be added. After boiling is finished, an amount of water equivalent to the amount evaporated is added to the sample wort, which can be left to stand at 95° C. for 60 minutes. The sample after filtration with a filter can be used as the tasting sample in the first present invention.

The method of the sensory evaluation is not particularly limited. An example of the method may suitably include a method in which three sensory evaluation panelists taste the tasting samples to evaluate the samples for “the fruity aroma intensity,” “the resin-like odor intensity,” and “the favorability” as comprehensive evaluation of both intensities. Each intensity is scored, and evaluation results of the fruity aroma (fruit flavor) intensity and the resin-like odor intensity can be represented in five grades: 1: “do not feel,” 2: “feel slightly,” 3: “feel,” 4: “feel a little intensely,” and 5: “feel intensely.” Additionally, the evaluation results of “the favorability” from the comprehensive evaluation of both fruity aroma intensity and resin-like odor intensity (that is, the comprehensive evaluation whether the fruity aroma derived from a hop or the like is imparted with a reduced off-flavor derived from the hop or the like) can be represented in three grades: 1: “not favorable,” 2: “slightly favorable,” and 3: “favorable.” In the first present invention, in the case where an evaluation is performed using these scores, an alcohol-free beer-taste sparkling beverage in which the fruity aroma intensity is scored 2 or more (preferably 3 or more, more preferably 4 or more), and in which the resin-like odor intensity is scored 4 or less (preferably 3 or less, more preferably 2 or less), and in which the resin-like odor intensity score does not exceed the fruity aroma intensity score can be considered to be “the alcohol-free beer-taste sparkling beverage imparted with a fruity aroma and a reduced off-flavor” in the present invention.

A-2. Production Method of the Second Present Invention

The production method of the second present invention is characterized by adjusting contents of myrcene, linalool, and nerol in a beverage to satisfy the following numerical ranges (a) to (e) of values quantified by GC/MS (hereinafter, the five numerical ranges are also referred to collectively as “5 numerical ranges”) by boiling the hop or the hop component in a raw material liquid, in production of an alcohol-free beer-taste sparkling beverage using a hop or a hop component (hereinafter, also referred to collectively as “hop or the like”).

(a) when an internal standard substance borneol is added to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration higher than 0.4 ppb, and
(d) a ratio of a value (%) of the ratio in (a) to a value (ppb) of the linalool concentration (hereinafter, also referred to merely as “myrcene/linalool”) being 5.2661 or less, and
(e) a ratio of the value (%) of the ratio in (a) to a value (ppb) of the nerol concentration (hereinafter, also referred to merely as “myrcene/nerol”) being 59.7692 or less.

Although the detailed mechanism is not known, when adjustment is performed to satisfy the above-described 5 numerical ranges, it is possible to produce an alcohol-free beer-taste sparkling beverage imparted with a fruity aroma derived from a hop or the like and a reduced off-flavor derived from the hop or the like. “The alcohol-free beer-taste sparkling beverage imparted with a fruity aroma and a reduced off-flavor” in the second present invention means an alcohol-free beer-taste sparkling beverage imparted with a fruity aroma derived from a hop or the like and a reduced off-flavor and of which off-flavor derived from a hop or the like (suitably a resin-like odor, an oil-like odor, more suitably a resin-like odor) is not so strong as to suppress the previously-described fruity aroma. Above all, in the case where intensities of the fruity aroma and the resin-like odor are each represented by a 5 grade score (1: “do not feel,” 2: “feel slightly,” 3: “feel,” 4: “feel a little intensely,” and 5: “feel intensely”), an example of the beverage may suitably include an alcohol-free beer-taste sparkling beverage in which the fruity aroma intensity score is 3 or more and the resin-like odor intensity score is 3 or less.

Examples of the “fruity aroma” in the second present invention are not particularly limited as long as the aroma is a fruity aroma derived from a hop or the like, and may suitably include a refreshing and lush fruity aroma, and above all, may more suitably include a muscat-like aroma. It should be noted that the presence or absence and extent of aromas such as these fruity aromas and of odors such as an off-flavor can be evaluated using sensory evaluation by panelists. Above all, an example of the sensory evaluation may suitably include a sensory evaluation using a score in which the intensities of aromas and odors are represented in five grades, as shown in Example 4 described below.

For each value quantified in the above-described 5 numerical ranges, it is possible to suitably use values analyzed and measured by GC/MS. Although methods and conditions for analysis and measurement with the aforesaid GC/MS or suitable methods and conditions are as described below, an example of the methods and conditions may particularly suitably include the conditions in Table 7 described below.

As the above-described numerical range (a), when an internal standard substance borneol is added to reach 25 ppb in the beverage sample, the ratio of the response value of an ion 93 m/z of myrcene to the response value of an ion 110 m/z of the internal standard substance borneol in the beverage sample may be less than 146.4%. From the viewpoint of reducing the resin-like odor intensity more and the like, an example of the response ratio may suitably include a ratio of 54.4% or less, may more suitably include a ratio of 36.5% or less, and may further suitably include a ratio in the range of 9.1% or more to 36.5% or less.

As the above-described numerical range (b), the linalool concentration may be 3.8 ppb or more. From the viewpoint of enhancing the fruity aroma relative to the off-flavor (particularly, the resin-like odor), an example of the linalool concentration may suitably include a concentration of 7.6 ppb or more, and may more suitably include a concentration of 18.7 ppb or more.

As the above-described numerical range (c), the nerol concentration may be higher than 0.4 ppb. From the viewpoint of enhancing the fruity aroma relative to the off-flavor (particularly, the resin-like odor), an example of the nerol concentration may suitably include a concentration of 0.6 ppb or more, and may more suitably include a concentration of 0.9 ppb or more.

As the above-described numerical range (d), the ratio of the value (%) of the ratio in the above-described (a) to the value (ppb) of the linalool concentration (myrcene/linalool) may be 5.2661 or less. From the viewpoint of enhancing the fruity aroma relative to the off-flavor (particularly, the resin-like odor), an example of the ratio (myrcene/linalool) may suitably include 3.7731 or less, and may more suitably include 2.9054 or less.

As the above-described numerical range (e), the ratio of the value (%) of the ratio in the above-described (a) to the value (ppb) of the nerol concentration (myrcene/nerol) may be 59.7692 or less. From the viewpoint of enhancing the fruity aroma relative to the off-flavor (particularly, the resin-like odor), an example of the nerol concentration may suitably include a concentration of 29.1071 or less, and may more suitably include a concentration of 25.9750 or less.

The type of the hop in the hop or the like used in the second present invention is not particularly limited as long as the hop may be used for production of a beer-taste sparkling beverage of the second present invention. Example of the hop may suitably include a hop variety containing linalool and/or nerol in a high content, above all, may more suitably include Motueka hop and Cascade hop, above all, may further suitably include Motueka hop from the viewpoint of obtaining a more suitable fruity aroma, and above all, may particularly suitably include Motueka hop produced in New Zealand. An example of the previously-described Cascade hop may suitably include Cascade hop produced in the United States. The hop or the like used in the production method of the second present invention may be one variety or may be two varieties or more. It should be noted that the above-described hop component means an aroma component derived from the hop, and examples of the aforesaid hop component may suitably include hop extract and hop essential oil.

“The hop containing linalool and/or nerol in a high content” in the second present invention mean a hop having a myrcene/linalool content of 5.2661 or less in a tasting sample obtained by use of the hop alone and by being prepared under the following conditions, and/or having a myrcene/nerol content of 59.7692 or less.

[Preparation of Tasting Samples in the Second Present Invention]

Tasting samples in the second present invention can be prepared using a 1.5 L scale apparatus. First, a feed wort with a sugar content of the feed wort adjusted to 13.5 degree (the ratio of malt used at feeding 67%, the ratio of auxiliary material used (rice, corn grits, and corn starch) 33%) can be provided as a sample wort. This sample wort can be heated and boiled with an electronic heater. At this time, boiling can be controlled such that the boiling intensity is constant and that the evaporation ratio reaches 10% in 60 minutes. It is possible to add 0.39 g/L to 0.55 g/L of the hop 5 minutes to 30 minutes before boiling of the sample wort is finished. After boiling is finished, an amount of water equivalent to the amount evaporated is added to the sample wort, which can be left to stand at 95° C. for 60 minutes. The sample after filtration with a filter can be used as the tasting sample in the second present invention.

The production method of the second present invention is not particularly different from the conventional production method of an alcohol-free beer-taste sparkling beverage using a hop or a hop component, except that adjustments are made to satisfy the above-described 5 numerical ranges. It is possible to extract a hop or the like with a raw material liquid containing a part or all of the raw materials other than hop-derived components, among raw materials of the aforesaid beer-taste sparkling beverage. An example of the raw material liquid may suitably include a wort containing malt, but the liquid may be a raw material liquid containing no malt (for example, a raw material liquid containing malt extract).

In the production method of the second present invention, the timing to add the hop or the like to a raw material liquid is not particularly limited as long as the aroma components of the aforesaid hop or the like are eluted into the raw material liquid. An example may suitably include addition to the raw material liquid under boiling. From the viewpoint of obtaining a suitable fruity aroma, an example may more suitably include addition such that the boiling time of the hop or the like falls within a range from 5 minutes to 30 minutes (preferably 5 minutes to 20 minutes). Proper boiling time of hop or the like depends on the type and production year of a hop and the like, and those skilled in the art can select a proper boiling time as appropriate, using a value quantified by GC/MS as an indicator. It should be noted that, in the second present invention, any conditions for extracting a hop or the like may be used without particular limitation, as long as the conditions are equivalent to those in the case where the hop or the like are boiled in the raw material liquid. For example, it is possible to employ methods for boiling the hop or the like separately from the raw material liquid and mixing the boiled product with the raw material liquid.

In the production method of the second present invention, a method for making adjustments to satisfy the above-described 5 numerical ranges is not particularly limited. An example of the method may suitably include a method for making adjustments to satisfy the above-described 5 numerical ranges by selecting the type and the amount of the hop or the like used, and production conditions such as boiling time of the hop or the like in the raw material liquid. Those skilled in the art may easily understand which production conditions to select such that adjustments may be made to satisfy the above-described 5 numerical ranges, by adjusting the type and the amount of the hop or the like used, and production conditions such as boiling time of the hop or the like in the raw material liquid as appropriate.

In the production method of the second present invention, the contents of myrcene, linalool, and nerol in a beverage can be adjusted by using values of the contents of myrcene, linalool, and nerol in the beverage analyzed and measured by GC/MS, as indicators. As the aforesaid GC/MS, commercially available apparatuses can be used without problems. Additionally, as a method for analysis and measurement by GC/MS, the known methods for analysis and measurement by GC/MS can be used. Above all, an example of the method may suitably include a method for analysis and measurement using Borneol as the internal standard substance, and above all, may more suitably include a method for analysis and measurement using the conditions described in Table 7 below. Additionally when each component in the beer-taste sparkling beverage is analyzed and measured with GC/MS, an example of the method may suitably include subjecting aroma components extracted from the aforesaid beer-taste sparkling beverage with a stationary phase column to GC/MS, and an example of the aforesaid stationary phase column may particularly suitably include a C18 stationary phase column.

In the second present invention, a particularly suitable method when contents of myrcene, linalool, and nerol in the beer-taste sparkling beverage are analyzed and measured by GC/MS is as follows. Aroma components in the beer-taste sparkling beverage are extracted with a C18 stationary phase column and are subjected to GC/MS. The internal standard method is used to quantify the components, and as the internal standard substance, borneol is added to reach 25 ppb in a beverage sample. As the analysis conditions, the conditions in Table 7 described below are used.

The production method of the present invention may have both the step (X) and step (Y). That is, in the step (Y), it is possible to use the step (X) as a device or one of devices for adjusting the contents of myrcene, linalool, and nerol in a beverage so as to satisfy the above-described 5 numerical ranges.

B. “an Alcohol-Free Beer-Taste Sparkling Beverage Imparted with a Fruity Aroma and a Reduced Off-Flavor” in the Present Invention

“An alcohol-free beer-taste sparkling beverage imparted with a fruity aroma and a reduced off-flavor” in the present invention is characterized by “being produced according to the production method of the first or second present invention,” or by “adjusting the contents of myrcene, linalool, and nerol in the beverage so as to satisfy the above-described 5 numerical ranges by boiling the hop or the hop component in the raw material liquid in production of an alcohol-free beer-taste sparkling beverage using a hop or a hop component.” Example of the beer-taste sparkling beverage of the present invention may suitably include beer-taste sparkling malt beverages containing malt. Additionally, to the beer-taste sparkling beverage of the present invention, flavoring agents may be added, as long as the beverage imparted with a fruity aroma derived from a hop or the like and a reduced off-flavor derived from the hop or the like.

B-1. The Beer-Taste Sparkling Beverage of the First Present Invention

“The alcohol-free beer-taste sparkling beverage imparted with a fruity aroma and a reduced off-flavor” in the first present invention (hereinafter, referred to merely as “the beer-taste sparkling beverage of the first present invention”) is characterized by being produced according to the production method of the first present invention. Although the detailed mechanism is not known, a beer-taste sparkling beverage produced by using a hop or the like stored and aged being in contact with air, preferably, a hop or the like stored and aged at the predetermined storage temperature for the predetermined storage period, as a hop or the like used during the raw material liquid-boiling step, will be an alcohol-free beer-taste sparkling beverage imparted with a fruity aroma derived from a hop or the like and a reduced off-flavor derived from the hop or the like.

B-2. The Beer-Taste Sparkling Beverage of the Second Present Invention

“The alcohol-free beer-taste sparkling beverage imparted with a fruity aroma and a reduced off-flavor” in the second present invention (hereinafter, referred to merely as “the beer-taste sparkling beverage of the second present invention”) is characterized in that, in the alcohol-free beer-taste sparkling beverage using a hop or the like, the contents of myrcene, linalool, and nerol in the beverage are prepared so as to satisfy the above-described 5 numerical ranges by being produced according to the production method of the second present invention. Although the detailed mechanism is not known, the beer-taste sparkling beverage prepared so as to satisfy the above-described 5 numerical ranges will be a beer-taste sparkling beverage imparted with a fruity aroma derived from a hop or the like and a reduced off-flavor derived from the hop or the like.

In the beer-taste sparkling beverage of the second present invention, a method for making preparation so as to satisfy the above-described 5 numerical ranges is not particularly limited. An example of the method may suitably include a method for making preparation so as to satisfy the above-described 5 numerical ranges by selecting the type and the amount of the hop or the like used, and production conditions such as boiling time of the hop or the like in the raw material liquid. As for the aforesaid production conditions, it is possible to select conditions similar to the production conditions previously described in relation to the production method of the second present invention. It should be noted that an example of the beer-taste sparkling beverage of the second present invention may suitably include a beer-taste sparkling beverage produced according to the production method of the second present invention.

Additionally, in the beer-taste sparkling beverage of the second present invention, adjustment of the contents of myrcene, linalool, and nerol in a beverage can be made by using values of the contents of myrcene, linalool, and nerol in the beer-taste sparkling beverage analyzed and measured by GC/MS, as indicators. The method for analysis and measurement by GC/MS is as previously described in relation to the production method of the second present invention.

Hereinbelow, the present invention is described in detail according to Examples, but the present invention is not intended to be limited to these Examples. It should be noted that Examples 1 to 2 described below relate to the first present invention and Examples 3 to 6 relate to the second present invention.

### Example 1

### Experiment in Relation to the First Present Invention

[Relationship Between Storage and Aging of Hops and Hop Essential Oil Components]

Before relationship between storage and aging of hops and the aroma of an alcohol-free beer-taste sparkling beverage was examined, relationship between storage and aging of hops and hop essential oil components was examined. Sealed Motueka hops produced in New Zealand were opened, and the hops were stored being in contact with air at the temperature (° C.) for the period (days) in Table 2 described below to perform storage and aging of the hops. Depending on the temperature (° C.) and period (days) of the storage and aging, eight test groups (test groups A to H) of the hops were provided. It should be noted that test group A is a test group using hops immediately before storage and aging.

Preparation of hop samples was made in a method as follows. 1 g of hop pieces was taken from the hop of each test group after storage and aging, and pulverized in a mortar. To each group, along with addition of 20 mL of dichloromethane, an internal standard substance, naphthalene was added to reach 2.5 ppm, and each sample was stirred for an hour. Then, each sample was dehydrated with anhydrous sodium sulfate to provide hop samples. Each of these hop samples was subjected to gas chromatography equipped with a mass spectrometer detector (GC/MS). Analysis conditions with the aforesaid GC/MS (analysis condition 1) are as in Table 1 below.

TABLE 1

| | |
|---|---|
| Capillary column | Trade name: HP-INNOWAX |
| | (length 60 m, inner diameter |
| | 0.25 mm, film thickness 0.25 μm) |
| Oven temperature | 40° C., 0.3 minutes-3° C./minute → |
| | 240° C., 20 minutes |
| Carrier gas | He, 10 psi Low pressure supply |
| Transfer line temperature | 240° C. |
| MS ion source temperature | 230° C. |
| MSQ pole temperature | 150° C. |
| Front inlet temperature | 200° C. |
| Monitoring ion | Hereinafter, same as quantitative ions |
| Ions used for quantification | |
| Naphthalene | m/z = 128 |
| Myrcene | m/z = 93 |
| Linalool | m/z = 93 |
| Nerol | m/z = 93 |
| Farnesene | m/z = 93 |
| Geranyl acetate | m/z = 69 |

As for the unit of quantification by GC/MS for each component, ppm was used for linalool. For myrcene, nerol, farnesene, and geranyl acetate, a ratio (%) obtained by dividing the response value of the quantitative ion in each of these components by the response value of the internal standard naphthalene ion 128 m/z was taken as the quantified value. The quantified values of each component of test groups A to H are shown in Table 2 below.

TABLE 2

| | Treatment | Hop components | | | | | |
|---|---|---|---|---|---|---|---|
| | conditions | | | | | | Geranyl |
| Test | Temperature | Time | Myrcene | Linalool | Nerol | Fanesene | acetate |
| groups | (° C.) | (days) | % | ppm | % | % | % |
| A | Not | | 2373.6 | 104.0 | 1.3 | 447.1 | 48.8 |
| | applicable | | | | | | |
| B | 20 | 5 | 1390.9 | 89.5 | 1.3 | 388.0 | 46.5 |
| C | 20 | 12 | 414.1 | 78.9 | 1.2 | 369.5 | 41.5 |
| D | 30 | 5 | 756.9 | 89.3 | 1.2 | 352.4 | 44.0 |
| E | 30 | 8 | 260.4 | 77.0 | 1.2 | 329.7 | 43.4 |
| F | 30 | 11 | 141.9 | 67.3 | 1.1 | 308.6 | 40.1 |
| G | 40 | 4 | 44.1 | 52.0 | 1.1 | 200.7 | 9.7 |
| H | 40 | 6 | 26.2 | 57.0 | 1.1 | 153.3 | 26.8 |

As can be seen from the result in Table 2, the myrcene component value at any storage and aging temperature was decreased more, as the storage and aging period became longer. In contrast, over a comparable storage and aging period (days), the value was decreased more as the storage and aging temperature (° C.) was increased. That is, it was observed that the myrcene component value tended to be inversely proportional to the storage and aging period (days), and, in contrast, that the value tended to be inversely proportional to the storage and aging temperature (° C.) over the comparable storage and aging period (days). Accordingly, myrcene was considered to be a particularly suitable indicator of component change associated with storage and aging of the hops. Additionally, there were some variations in the relationship between the storage and aging period (days) and the values of the components, but a tendency similar to myrcene was observed also in linalool and farnesene. Thus, these components were also considered to be able to be used as indicators of component change associated with storage and aging of the hops. On one part, for nerol, not so many conversions due to differences in the storage and aging temperature and the storage and aging period were observed. On the other part, for geranyl acetate, noticeable differences were not observed in the storage and aging at 20° C. and 30° C., but the component values were decreased in any case as the storage and aging period became longer. However, for geranyl acetate, in the storage and aging at 40° C., the component value was greatly increased, although the storage and aging period became longer. Thus, it was not possible to find a relationship having a consistent tendency between the storage and aging period and the component value. That is, it was found that geranyl acetate was not to be a clear indicator of component change associated with the storage and aging of the hops.

It should be noted that, as previously described, myrcene was considered to be a particularly suitable indicator of component change associated with the storage and aging of the hops. Then, of each test group in the above-described Table 2, test groups B to H excluding test group A, which is the control, multiple regression analysis on the relationship between the myrcene content (%) in the hops and the storage temperature (° C.) and the storage period (days) of the storage and aging of the hops was attempted. As a result, the following multiple regression equation was obtained:

[myrcene content (%)]=3184.94−63.616×[storage temperature (° C.)]−115.700×[storage period (days)].

Since the correlation coefficient (y) of the aforesaid multiple regression equation was 0.97, which was extremely high, it was demonstrated that myrcene was extremely suitable as an indicator of component change associated with the storage and aging of the hops. The aforesaid multiple regression equation is particularly important in that the equation indicates that the myrcene content (%) in the hops can be controlled by adjustment of the storage temperature (° C.) and storage period (days) of the hops. It should be understood that, considering that the myrcene content is decreased as the storage and aging proceed, the degree of decrease in myrcene can be used as an indicator representing the degree of the storage and aging of the hops. Accordingly, the above-described multiple regression equation leads to a relational equation as follows:

(Degree of storage and aging of the hops)=63.616×[storage temperature (° C.)]+115.700×[storage period (days)].

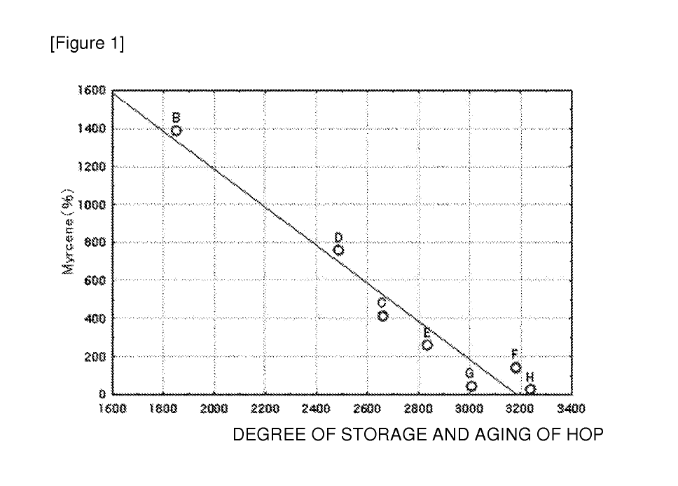

In FIG. 1, the results of test groups B to H in the above-described Table 2 were plotted with the value of this “degree of storage and aging of the hops” as the horizontal axis and the myrcene content (%) as the vertical axis, and additionally, the result of the above-described multiple regression equation was depicted.

According to FIG. 1, it is possible to understand that the myrcene content (%) of each test group is decreased along the straight line of the above-described multiple regression equation as the degree of storage and aging of the hops is increased.

### Example 2

### Confirmation of the Aroma Characteristics of Stored and Aged Hops and Validation Thereof from Chemical Components

In order to confirm the aroma characteristics of an alcohol-free beer-taste beverage using stored and aged hops from sensory and chemical component aspects, tasting samples were prepared using the stored and aged hops in Example 1, and sensory evaluation and chemical analysis were performed on the tasting samples.

(1) Preparation of Tasting Samples

Tasting samples were prepared using a 1.5 L scale apparatus. First, a feed wort with a sugar content of the feed wort adjusted to 1.0 degree (the ratio of malt used at feeding 67%, the ratio of adjuncts used (rice, corn grits, and corn starch) 33%) was provided as a sample wort. This sample wort was heated and boiled with an electronic heater. At this time, boiling was controlled such that the boiling intensity was constant and that the evaporation ratio reached 10% in 60 minutes. When boiling of the sample wort was finished, 2.5 g/L of the hop of each test group stored and aged in the above-described Example 1 was added. After boiling was finished, an amount of water equivalent to the amount evaporated was added to the sample wort, which was left to stand at 95° C. for 60 minutes. After filtration with a filter, the sample wort was cooled with iced water, and the sample was diluted 5 fold with distilled water to thereby provide a tasting sample. It should be noted that the test group of the tasting sample prepared using the hop of test group A was designated as #1, the test group of the tasting sample prepared using the hop of test group B was designated as #2, the test group of the tasting sample prepared using the hop of test group C was designated as #3, the test group of the tasting sample prepared using the hop of test group D was designated as #4, the test group of the tasting sample prepared using the hop of test group E was designated as #5, the test group of the tasting sample prepared using the hop of test group F was designated as #6, the test group of the tasting sample prepared using the hop of test group G was designated as #7, and the test group of the tasting sample prepared using the hop of test group H was designated as #8.

(2) Sensory Evaluation on the Tasting Samples

Sensory evaluation was performed on each tasting sample of test groups #1 to #8 prepared in the above-described (1) of Example 2. The sensory evaluation was performed by three sensory evaluation panelists, who tasted the tasting samples to evaluate “the fruity aroma intensity,” “the resin-like odor intensity,” and “the favorability” as the comprehensive evaluation of both intensities. Each intensity was scored, and evaluation results of the fruity aroma (fruit flavor) intensity and the resin-like odor intensity were represented in five grades: 1: “do not feel,” 2: “feel slightly,” 3: “feel,” 4: “feel a little intensely,” and 5: “feel intensely.” Additionally, the evaluation results of “the favorability” from the comprehensive evaluation of both fruity aroma intensity and resin-like odor intensity (that is, the comprehensive evaluation whether the fruity aroma derived from a hop or the like was imparted with a reduced off-flavor derived from the hop or the like) were represented in three grades: 1: “not favorable,” 2: “slightly favorable,” and 3: “favorable.” The result of this sensory evaluation is shown in Table 3 below.

TABLE 3

| | | | | | | | | Sensory evaluation | | |
|---|---|---|---|---|---|---|---|---|---|---|
| | Treatment conditions | | Hop components | | | | | | Resin- | Comprehensive |
| Test | Temperature | Time | | Linalool | Nerol | Myrcene/ | Myrcene/ | Fruit | like | evaluation |
| groups | (° C.) | (days) | Myrcene % | ppb | ppb | Linalool | Nerol | flavor | odor | (favorability) |
| #1 | Not | 0 | 323.8 | 31.4 | 1.7 | 10.2995 | 192.7472 | 4 | 5 | 2 |
| | applicable | | | | | | | | | |
| #2 | 20 | 5 | 304.8 | 33.6 | 1.9 | 9.0712 | 162.1230 | 4 | 5 | 2 |
| #3 | 20 | 12 | 96.6 | 31.6 | 2.0 | 3.0561 | 47.8090 | 4 | 3 | 3 |
| #4 | 30 | 5 | 187.8 | 31.8 | 1.8 | 5.9091 | 105.5002 | 4 | 4 | 2 |
| #5 | 30 | 8 | 88.4 | 31.0 | 1.9 | 2.8561 | 47.5402 | 4 | 2 | 3 |
| #6 | 30 | 11 | 43.7 | 30.9 | 1.9 | 1.4158 | 22.7712 | 4 | 2 | 3 |
| #7 | 40 | 4 | 25.6 | 26.5 | 1.9 | 0.9683 | 13.3438 | 3 | 2 | 3 |
| #8 | 40 | 6 | 21.3 | 22.2 | 1.8 | 0.9568 | 11.5543 | 2 | 2 | 3 |

| | | | | | |
|---|---|---|---|---|---|
| Desired component range | Less than | 3.8 ppb | 0.4 ppb | 5.2661 | 59.7692 |
| | 146.4%, | or more | or more, | or less | or less |
| | desirably | | desirably | | |
| | 54.4% | | 0.6 ppb | | |
| | or less | | or more | | |

In the case of storage and aging at any temperature, the aroma changed in response to the storage and aging period. For example, in the case of storage and aging at 20° C. (test groups #2 and #3), the fruity aroma intensity was relatively as high as 4 in any test group (storage and aging of 5 and 12 days). Additionally, the resin-like odor intensity was as high as 5 in test group #2 (storage and aging of 5 days), but was decreased to 3 in test group #3 (storage and aging of 12 days), and at the same time, the comprehensive evaluation was increased from 2 to 3. Alternatively, in the case of storage and aging at 30° C. (test groups #4, #5, and #6), the fruity aroma intensity was relatively as high as 4, in any test group (a storage and aging period of 5 days, 8 days, and 11 days). Additionally, the resin-like odor intensity was relatively as high as 4 in test group #4 (a storage and aging period of 5 days), but was decreased to 2 in test group #5 (a storage and aging period of 8 days) and test group #6 (a storage and aging period of 11 days), and at the same time, the comprehensive evaluation was increased from 2 to 3. Alternatively, in the case of storage and aging at 40° C. (test groups #7 and #8), the fruity aroma intensity was 3 in test group #7 (a storage and aging period of 4 days), and 2 in test group #8 (a storage and aging period of 6 days). However, since the resin-like odor intensity was relatively as low as 2 in either of the test groups, the comprehensive evaluation was 3 in either of the test groups. From these results, in the case of storing and aging hops (suitably, Motueka hop), it was indicated that the storage and aging period was suitably more than 5 days to 12 days or less at 20° C., suitably more than 5 days to 11 days or less at 30° C., and suitably 4 days or more to 6 days or less at 40° C.

Additionally, as a result of comparing the previously-described Table 2 showing the measured results of the hop essential oil components of the stored and aged hops with previously-described Table 3 showing the results of the sensory evaluation of the tasting samples produced by using these hops, it was found to be suitable that the measured value of myrcene in the hop essential oil components (myrcene content (%)) was less than 756.9% (see the myrcene content of test group D), preferably 414.1% (see the myrcene content of test group C) or less, and more preferably 414.1% or less and 26.2% (see the myrcene content of test group H) or more in order for the tasting samples to achieve 3 in the comprehensive evaluation. Additionally, when a suitable range of the previously-described “degree of storage and aging of the hops” was derived from the result of the suitable myrcene content (%) in the hops, it was found to be suitable that the value of the degree of storage and aging of the hops was more than 2487 (test group D: 30° C., 5 days), preferably 2660 (test group C: 20° C., 12 days) or more, and more preferably 2660 or more to 3239 (test group H: 40° C., 6 minutes) or less. Use of hops having such a degree of suitable storage and aging makes it possible to control the myrcene content (%) in the hops within a suitable range, and thus makes the sensory evaluation of the tasting samples produced by using the aforesaid hops suitable. It should be noted that a refreshing and lush fruity aroma, particularly a muscat-like aroma was felt from each tasting sample of test groups #3, #5, #6, #7, and #8 having 3 in the comprehensive evaluation.

(3) Chemical Analysis of the Tasting Samples

The inventors of the present application have obtained findings that, in production of an alcohol-free beer-taste sparkling beverage, an alcohol-free beer-taste sparkling beverage imparted with a fruity aroma and a reduced off-flavor can be obtained by adjusting the contents of myrcene, linalool, and nerol in the beverage to satisfy numerical ranges of values quantified by GC/MS in the following (a) to (e), from experiments described below in relation to the second invention (see Examples 3 to 5 described below).

(a) when an internal standard substance borneol is added so as to reach 25 ppb in a beverage sample, a ratio of a response value of an ion 93 m/z of myrcene to a response value of an ion 110 m/z of the internal standard substance borneol in the beverage sample is less than 146.4%, and
(b) a linalool concentration is 3.8 ppb or more, and
(c) a nerol concentration is higher than 0.4 ppb, and
(d) a ratio of a value (%) of the ratio in the (a) to the value (ppb) of the linalool concentration is 5.2661 or less, and
(e) a ratio of the value (%) of the ratio in the (a) to a value (ppb) of the nerol concentration is 59.7692 or less.

To confirm the relationship between the contents of myrcene, linalool, and nerol in the tasting samples using stored and aged hops (the tasting samples of the first present invention) and the above-described five numerical ranges (a) to (e) by way of precaution, chemical analysis using GC/MS was performed on each tasting sample of test groups #1 to #8 prepared in the above-described (1) of Example 2. GC/MS analysis was performed by extracting aroma components in the tasting samples of each test group with a C18 stationary phase column and subjecting the components to GC/MS. The internal standard method was used to quantify the components. As the internal standard substance, borneol was used and added so as to reach 25 ppb in the beverage samples. The analysis conditions of GC/MS (analysis conditions 2) are described in Table 4.

TABLE 4

| | |
|---|---|
| Capillary column | Trade name: HP-INNOWAX |
| | (length 60 m, inner diameter 0.25 |
| | mm, film thickness 0.25 μm) |
| Oven temperature | 40° C., 0.3 minutes-3° C./minute → |
| | 240° C., 20 minutes |
| Carrier gas | He, 10 psi Low pressure supply |
| Transfer line temperature | 240° C. |
| MS ion source temperature | 230° C. |
| MSQ pole temperature | 150° C. |
| Front inlet temperature | 200° C. |
| Monitoring ion | Hereinafter, same as quantitative ions |
| Ions used for quantification | |
| Borneol | m/z = 110 |
| Myrcene | m/z = 93 |
| Linalool | m/z = 93 |
| Nerol | m/z = 93 |

As for the unit of quantification by GC/MS for each component, ppb was used. For myrcene, a ratio (%) obtained by dividing the response value of the quantitative ion by the response value of the internal standard borneol ion 110 m/z was considered the quantified value. The quantified values in the above-described five numerical ranges (a) to (e) in each tasting sample of test groups #1 to #8 are shown in the previously-described Table 3. It should be noted that when the quantified values of the components in the tasting samples satisfy any of the above-described numerical ranges (a) to (e), the numeric value of the item is represented in bold and underlined.

When the result of the quantified values of the components in Table 3 was compared with the result of the sensory evaluation in Table 3, the suitable content of myrcene as an indicator of component change associated with the storage and aging of the hops was decreased as the storage and aging period became longer. This change showed a tendency consistent with the decrease in the resin-like odor intensity in the sensory evaluation. In contrast, for linalool, although not so much as myrcene, it was observed that the content tended to be gradually decreased as the storage and aging period became longer or the storage temperature was increased, whereas, for nerol, change due to storage and aging was hardly observed. The fact that the contents of linalool and nerol were not decreased so much by the storage and aging was consistent with the fact that the fruity aroma intensity in the sensory evaluation was not decreased so much. Particularly, in the case where the storage and aging temperature was 20° C. or 30° C. (test groups #2 to #6), the fact that the contents of linalool and nerol were hardly decreased was consistent with the fact that the fruity aroma of the test groups in the sensory evaluation was 4 in any case. Additionally, in the case of storage and aging at 30° C. (test groups #4 to #6), myrcene was as high as 187.8%, and the ratios to linalool and to nerol were as high as 5.90 and 105.5, respectively in test group #4 (storage and aging period of 5 days). Due to the high myrcene content, the resin-like odor intensity in the sensory evaluation was also as high as 4, and thus, the comprehensive evaluation achieved 2. For test group #5 (storage and aging period of 8 days) and test group #6 (storage and aging period of 11 days), the content of myrcene was low and the resin-like odor intensity was decreased to 2, so that the comprehensive evaluation was increased to 3. Alternatively, in the case of storage and aging at 40° C. (test groups #7 and #8), the contents of linalool and nerol were not so high and the fruity aroma intensity stayed at 3 (test group #7) or at 2 (test group #8). However, since the myrcene content was low and the resin-like odor intensity was 2 in both the test groups, the comprehensive evaluation was 3 in both the test groups.

It should be noted that the current commercially available beer-taste sparkling beverages having an alcohol content of 0.00% (w/w) were subjected to sensory evaluation. However, there were neither commercially available products in which an aroma such as newly found in the present invention, that is, an fruity aroma derived from a hop or the like was clearly felt, nor commercially available products imparted with a fruity aroma derived from a hop or the like and a reduced off-flavor derived from the hop or the like.

### Example 3

### Experiment in Relation to the Second Present Invention

[Choice of Hop Variety]

To choose a suitable hop variety for imparting a fruity aroma, preparation and sensory evaluation of tasting samples were performed. Tasting samples were prepared using a 1.5 L scale apparatus. First, a feed wort with a sugar content of the feed wort adjusted to 13.5 degree (the ratio of malt used at feeding 67%, the ratio of adjuncts used (rice, corn grits, and corn starch) 33%) was provided as a sample wort. This sample wort was heated and boiled with an electronic heater. At this time, boiling was controlled such that the boiling intensity is constant and that the evaporation ratio reached 10% in 60 minutes. A hop was added at 0.5 g/L, 5 minutes before boiling of the sample wort was finished. After boiling was finished, an amount of water equivalent to the amount evaporated was added to the sample wort, which was left to stand at 95° C. for 60 minutes. Samples after filtration with a filter were used as tasting samples. The hop varieties used were Saaz produced in Czech, Hersbrucker produced in Germany, Northern Brewer produced in Germany, Motueka produced in New Zealand, and Cascade produced in the United States. More specifically, tasting samples were prepared using the hop varieties in Table 5 described below in the amount to be added described in Table 5. It should be noted that a hop was added in any of the test groups 5 minutes before boiling of the sample wort was finished. Three sensory evaluation panelists tasted the tasting samples to qualitatively evaluate the aroma characteristics. The result is shown in Table 5.

TABLE 5
Hops

| | | | Production country | | | | |
|---|---|---|---|---|---|---|---|
| | | | | | | New | The United |
| | | | Czech | Germany | Germany | Zealand | States |
| | Variety | | Saaz | Hersbrucker | Northern | Motueka | Cascade |
| | | | | | Brewer | | |
| | Amount used | g/L | 0.5 | 0.5 | 0.5 | 0.5 | 0.5 |
| Addition timing | Boiling time | Minute | 5 | 5 | 5 | 5 | 5 |
| Aroma | | | Floral | Floral | Floral | Fruity | Fruity Slightly |
| characteristic | | | | Spicy | | | heavy aroma |

From the tasting sample using Motueka hop produced in New Zealand, a refreshing and lush fruity aroma, particularly a muscat-like aroma was felt. Although a fruity aroma was felt from the tasting sample using Cascade hop produced in the United States, it was a fruity aroma that was associated with a slightly heavier aroma compared to the previously-described tasting sample using Motueka hop. It was impossible to confirm the intended fruity aroma in the tasting samples using hops of the other varieties. Thus, it was found that Motueka and Cascade hops were suitable for the production of a non-fermented beer-taste sparkling beverage having a fruity aroma. Above all, in the case where Motueka hop was used, the hop was considered particularly suitable in that the fruity aroma was refreshing and lush and that a muscat-like aroma was felt.

### Example 4

### Search for an Indicator of Hop Aroma Components in Relation to Sensory Evaluation of Fruity Aromas

In the above-described Example 3, in order to investigate hop aroma components from which the fruity aroma obtained using Motueka hop was derived, Motueka hops having different lot numbers (production year) were provided. Tasting samples were prepared under the conditions of amounts of hops added from 0.39 g/L to 0.55 g/L and boiling times from 5 minutes to 10 minutes (Table 6), and sensory evaluation was performed on the tasting samples. The sensory evaluation was performed by three sensory evaluation panelists, who tasted the tasting samples to evaluate “the fruity aroma intensity,” “the resin-like odor intensity,” and “the favorability” as the comprehensive evaluation of both intensities. Each intensity was scored, and evaluation results of the fruity aroma (fruit flavor) intensity and the resin-like odor intensity were represented in five grades: 1: “do not feel,” 2: “feel slightly,” 3: “feel,” 4: “feel a little intensely,” and 5: “feel intensely.” Additionally, the evaluation results of “the favorability” from the comprehensive evaluation of both fruity aroma intensity and resin-like odor intensity (that is, the comprehensive evaluation whether the fruity aroma derived from a hop or the like was imparted with a reduced off-flavor derived from the hop or the like) were represented in three grades: 1: “not favorable,” 2: “slightly favorable,” and 3: “favorable.” The result of this sensory evaluation is shown in Table 6.

TABLE 6

| | | | Test groups | | | | | | | | |
|---|---|---|---|---|---|---|---|---|---|---|---|
| | | | #1 | #2 | #3 | #4 | #5 | #6 | #7 | #8 | #9 |
| Amount of hop used | Motueka | g/L | 0.49 | 0.41 | 0.41 | 0.43 | 0.45 | 0.55 | 0.53 | 0.39 | 0.43 |
| | Lot number | | 2856-1 | 2856-1 | 2856-1 | 2856-1 | 2856-1 | 2856-1 | 2738-1 | 2738-1 | 2738-1 |
| Addition timing | Boiling time | Minute | 5 | 5 | 5 | 5 | 5 | 10 | 5 | 5 | 5 |
| Sensory evaluation | Fruit flavor | | 5 | 5 | 3 | 3 | 3 | 4 | 3 | 3 | 3 |
| | Resin-like odor | | 5 | 5 | 5 | 5 | 5 | 5 | 3 | 3 | 3 |
| | Comprehensive | | 2 | 2 | 1 | 1 | 1 | 2 | 3 | 3 | 3 |
| | evaluation | | | | | | | | | | |
| | (favorability) | | | | | | | | | | |
| Hop components | Myrcene | % | 377.1 | 236.8 | 146.4 | 169.6 | 247.1 | 291.0 | 54.4 | 9.1 | 11.6 |
| | Linalool | ppb | 131.9 | 95.3 | 21.6 | 19.3 | 24.3 | 59.0 | 18.7 | 18.9 | 21.9 |
| | β-Caryophyllene | % | 0.9 | 0.8 | 0.4 | 1.1 | 1.0 | 1.3 | 0.3 | 0.2 | 0.2 |
| | α-Humulene | % | 1.6 | 0.9 | 1.4 | 7.2 | 7.2 | 5.2 | 0.3 | 0.7 | 0.4 |
| | Citronellol | ppb | 2.2 | 1.9 | 2.0 | 1.5 | 1.7 | 1.1 | 1.6 | 2.6 | 2.2 |
| | Nerol | ppb | 2.8 | 2.5 | 1.1 | 1.0 | 1.3 | 2.2 | 0.9 | 0.6 | 1.0 |

Depending on the production year (lot number) of the hop, the amount to be added, and the boiling time, differences in the fruity aroma intensity, the resin-like odor intensity, and the comprehensive evaluation (favorability) were observed. In any of test groups #7, #8, and #9, which scored 3, the highest in the comprehensive evaluation, the fruity aroma intensity was 3 and the resin-like odor intensity was 3. In these test groups, although the resin-like odor was also felt, the intensity was not so strong as to suppress the fruity aroma, and thus, the comprehensive evaluation was 3, which was the highest. In test groups #1 and #2, although the fruity aroma intensity was as high as 5, the resin-like odor intensity was also as high as 5, and the fruity aroma was suppressed. Thus, the comprehensive evaluation stayed at 2. In any of test groups #3, #4, and #5, although the fruity aroma intensity was 3, the resin-like odor intensity was as high as 5, and the fruity aroma was strongly suppressed. Thus, comprehensive evaluation was 1, which was the lowest. In test group #6, although the fruity aroma intensity was as slightly high as 4, the resin-like odor intensity was also as high as 5, and the fruity aroma was suppressed. Thus the comprehensive evaluation stayed at 2.

Subsequently, in order to investigate the relationship between the sensory evaluation of the tasting samples of test groups #1 to #9 in the previously-described Table 6 and the chemical components, analysis of the tasting samples of test groups #1 to #9 in Table 6 was performed first using gas chromatography equipped with a mass spectrometer detector (GC/MS). GC/MS analysis was performed by extracting aroma components in the tasting samples of each test group with a C18 stationary phase column and subjecting the components to GC/MS. The internal standard method was used to quantify the components. As the internal standard substance, borneol was used and added so as to reach 25 ppb in the beverage samples. The analysis conditions of GC/MS were described in Table 7.

TABLE 7

| | |
|---|---|
| Capillary column | Trade name: HP-INNOWAX |
| | (length 60 m, inner diameter 0.25 |
| | mm, film thickness 0.25 μm) |
| Oven temperature | 40° C., 0.3 minutes-3° C./minute → |
| | 240° C., 20 minutes |
| Carrier gas | He, 10 psi Low pressure supply |
| Transfer line temperature | 240° C. |
| MS ion source temperature | 230° C. |
| MSQ pole temperature | 150° C. |
| Front inlet temperature | 200° C. |
| Monitoring ion | Hereinafter, same as quantitative ions |
| Ions used for quantification | |
| Borneol | m/z = 110 |
| Myrcene | m/z = 93 |
| Linalool | m/z = 93 |
| β-Caryophyllene | m/z = 93 |
| α-Humulene | m/z = 93 |
| Citronellol | m/z = 69 |
| Nerol | m/z = 93 |

As for the unit of quantification by GC/MS for each component, ppb was used. For myrcene, α-humulene, and 13-caryophyllene, a ratio (%) obtained by dividing the response value of the quantitative ion of each of these components by the response value of the internal standard borneol ion 110 m/z was considered the quantified value. The quantified values of each component of test groups #1 to #9 are shown in the previously-described Table 6.

In order to investigate the relationship between each sensory evaluation of the tasting samples of test groups #1 to #9 in the previously-described Table 6 and the chemical components, correlation coefficients between the score of the fruity aroma (fruit flavor) intensity, the score of the resin-like odor intensity, and the score of the comprehensive evaluation in these tasting samples and each component value listed in Table 6 were calculated. The result is shown in Table 8.

TABLE 8
Correlation coefficient

| | | | Comprehensive |
|---|---|---|---|
| | | Resin-like | evaluation |
| | Fruit flavor | odor | (favorability) |
| Myrcene | 0.7277 | 0.8523 | −0.5467 |
| Linalool | 0.9724 | 0.4660 | −0.0198 |
| β-Caryophyllene | 0.4143 | 0.8116 | −0.6289 |
| α-Humulene | −0.1717 | 0.5941 | −0.7131 |
| Citronellol | 0.0086 | −0.4407 | 0.3880 |
| Nerol | 0.9570 | 0.6184 | −0.1649 |

Since the correlation coefficient obtained between the score of the fruity aroma intensity and the linalool component value (ppb) was as high as 0.9724, and the correlation coefficient obtained between the score of the fruity aroma intensity and the nerol component value (ppb) was as high as 0.9570, it was indicated that linalool and nerol may become suitable indicators of the fruity aroma. In contrast, between the score of the resin-like odor intensity and the myrcene component value (%), obtained was a correlation coefficient of 0.8523, which was the highest. Alternatively, between the score of the comprehensive evaluation (favorability) and any of the component values, it was not able to obtain a high correlation coefficient of which absolute value was to be 0.8 or more. Accordingly, the comprehensive evaluation was considered to be based on the balance between the fruity aroma intensity and the resin-like odor intensity, and the correlation with the component ratio was investigated. As components used for the component ratios, the candidate components for the indicator of the fruity aroma, linalool and nerol, and the candidate component for the indicator of the resin-like odor, myrcene, which were observed to have the above-described correlation, were selected. A ratio (myrcene/linalool) obtained by dividing the quantified value (%) of myrcene by the quantified value (ppb) of linalool and a ratio (myrcene/nerol) obtained by dividing the quantified value (%) of myrcene by the quantified value (ppb) of nerol were calculated, and the correlation coefficients between these ratios and the comprehensive evaluation scores were investigated. The result is shown in Table 9.

TABLE 9

| | | | Comprehensive |
|---|---|---|---|
| | | | evaluation |
| Test groups | Myrcene/Linalool | Myrcene/Nerol | (favorability) |
| #1 | 2.8590 | 134.6786 | 2 |
| #2 | 2.4848 | 94.7200 | 2 |
| #3 | 6.7854 | 129.5221 | 1 |
| #4 | 8.7972 | 167.9307 | 1 |
| #5 | 10.1612 | 185.8045 | 1 |
| #6 | 4.9335 | 134.0806 | 2 |
| #7 | 2.9054 | 59.7692 | 3 |
| #8 | 0.4841 | 14.2813 | 3 |
| #9 | 0.5290 | 11.2330 | 3 |
| Correlation | −0.9043 | −0.9086 | |
| coefficient | | | |
| Comprehensive | | | |
| evaluation | | | |
| (favorability) | | | |

Between the comprehensive evaluation score and either of myrcene/linanol and myrcene/nerol, a negative correlation coefficient as high as of the order of −0.9 was obtained. From this, it was indicated that these component ratios might be suitable indicators of the comprehensive evaluation (that is, the comprehensive evaluation whether the fruity aroma derived from a hop or the like was imparted with a reduced off-flavor derived from the hop or the like).

### Example 5

### Validation of the Effectivity of the Indicator Components and Setting of the Numerical Ranges of the Indicator Components

In order to further validate the relationship between the components obtained in the above-described Example 4 and the sensory evaluation, preparation and sensory evaluation of tasting samples were further performed. Tasting samples (test groups #10 to #14) were prepared in the same method as in the above-described Example 3 except that the amount of Motueka hop added was 0.53 g/L and the boiling time was as listed in Table 10 described below. In comparison with the test in Table 6, the boiling time of the hop was extended and the component value was changed. The quantified values obtained by analysis of each component value of the aforesaid tasting samples by GC/MS are shown in Table 10. It should be noted that the same method was used for analysis by GC/MS as in the above-described Example 4.

TABLE 10

| | | | Test groups | | | | |
|---|---|---|---|---|---|---|---|
| | | | #10 | #11 | #12 | #13 | #14 |
| Amount of hop used | Motueka | g/L | 0.53 | 0.53 | 0.53 | 0.53 | 0.53 |
| | Lot number | | 2856-6 | 2856-6 | 2738-1 | 2738-1 | 2738-1 |
| Addition timing | Boiling time | Minute | 30 | 20 | 30 | 20 | 10 |
| Sensory evaluation | Fruit flavor | | 1 | 3 | 1 | 3 | 3 |
| | Resin-like odor | | 2 | 2 | 3 | 3 | 2 |
| | Comprehensive | | 1 | 3 | 1 | 3 | 3 |
| | evaluation | | | | | | |
| | (favorability) | | | | | | |
| | Myrcene | % | 22.0 | 28.6 | 14.6 | 20.1 | 36.5 |
| | Linalool | ppb | 1.8 | 7.6 | 2.1 | 3.8 | 22.2 |
| Hop components | Nerol | ppb | 0.4 | 1.0 | 0.4 | 0.7 | 1.4 |
| | Myrcene/Linalool | | 12.3137 | 3.7731 | 7.0339 | 5.2661 | 1.6440 |
| | Myrcene/Nerol | | 52.3333 | 29.1071 | 34.5833 | 27.3333 | 25.9750 |

Consequently, in test groups #11, #13, and #14, the fruity aroma intensity was 3, the resin-like odor intensity was 2 or 3, and the comprehensive evaluation was 3. In contrast, in test groups #10 and #12, although the resin-like odor was 2 or 3, which was not so high, the fruity aroma intensity was 1, which was the lowest, and thus, the comprehensive evaluation was 1, which was the lowest.

The sensory evaluation, each component value (ppb or %), and component ratios listed in the previously-described Tables 6, 9, and 10 were summarized, the test groups were sorted in the descending order of the comprehensive evaluation score, and the range of the component values and the range of the component ratios for imparting a fruity aroma derived from a hop or the like with a reduced off-flavor derived from the hop or the like were investigated (Table 11).

TABLE 11

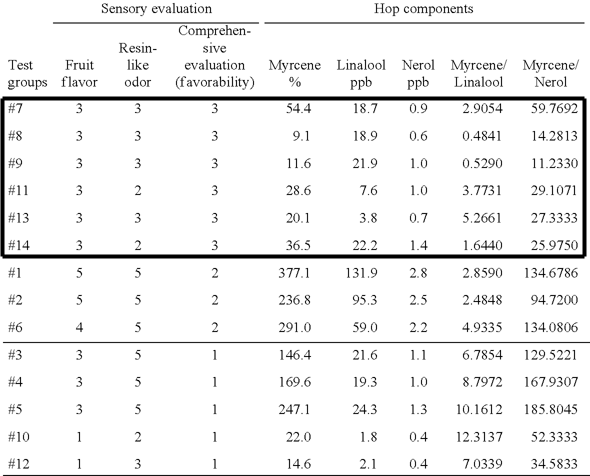

The test groups achieved 3, which is the highest in the comprehensive evaluation, are the test groups (#7 to 9, #11, #13, and #14) within a thick frame. The test groups having a comprehensive evaluation of 3 were considered to be test groups imparted with a fruity aroma and a reduced off-flavor. In the test groups having a comprehensive evaluation of 3 within the thick frame, the fruity aroma was 3 in all the groups, and the resin-like odor was 2 or 3. Hereinbelow, the relationship between the comprehensive evaluation, the fruity aroma intensity, and the resin-like odor intensity was discussed first. The favorability as the comprehensive evaluation is considered to be composed of the resin-like odor, which is an unusual odor, present at a certain intensity or less and the intended fruity aroma present at a certain intensity or more. Accordingly, it follows that, if “the favorability” from Table 11 is defined by the resin-like odor intensity and the fruity aroma intensity, having a resin-like odor intensity of 3 or less and a fruity aroma intensity of 3 or more is desired. In fact, the test groups having a comprehensive evaluation of 2 or 1 do not satisfy these conditions (Table 11).

This definition is redefined by the quantified values (ppb or %) of the candidate component for the indicator of the resin-like odor, myrcene and the candidate components for the indicator of the fruity aroma, linalool and nerol obtained in Table 8 as follows. That is, a numerical range in which (A) the resin-like odor intensity is 3 or less: the quantified value of myrcene is less than 146.4% (test group #3), preferably 54.4% (test group #7) or less, and more preferably 36.5% (test group #14) or less, and (B) the fruity aroma intensity is 3 or more: the quantified value of linalool is 3.8 ppb (test group #13) or more, preferably 7.6 ppb (test group #11) or more, and more preferably 18.7 ppb (test group #7) or more, and the quantified value of nerol is higher than 0.4 ppb (test groups #10 and #13), preferably 0.6 ppb (test group #8) or more, and more preferably 0.9 ppb (test group #7) or more was obtained.

In contrast, when the comprehensive evaluation “the favorability” is represented by the component composition ratio obtained in Table 9, it follows that myrcene/linanol and myrcene/nerol are desirably certain upper values or less. Considering myrcene/linanol and myrcene/nerol in the test groups (#7 to 9, #11, #13, and #14) that achieved 3, which is the highest in the comprehensive evaluation, in the previously-described Table 11, the comprehensive evaluation “the favorability” is more specifically defined as follows. That is, a numerical range of the composition ratio of (C) the comprehensive evaluation “the favorability” is 3: myrcene/linanol is 5.2661 (test group #13) or less, preferably 3.7731 (test group #11) or less, and more preferably 2.9054 (test group #7) or less, and myrcene/nerol is 59.7692 (test group #7) or less, preferably 29.1071 (test group #11) or less, and more preferably 25.9750 (test group #14) was obtained.

### Example 6

### Analysis Result of Commercially Available Products

Current commercially available beer-taste sparkling beverages having an alcohol content of 0.00% (w/w) were subjected to sensory evaluation. However, there were neither commercially available products in which an aroma such as newly found in the second present invention, that is, a fruity aroma derived from a hop or the like was clearly felt, nor commercially available products imparted with a fruity aroma derived from a hop or the like and a reduced off-flavor derived from the hop or the like. Thus, the quantified values of the commercially available products should not simultaneously satisfy the numerical ranges of all of the five indicators identified in the above-described Example 5. Each quantified value of three commercially available products is shown in Table 12. Of each quantified value of the commercially available products, the quantified values of the types of indicators that satisfy the numerical ranges identified in the above-described Example 5 are shown in bold and underlined.

TABLE 12

| | | | Commercially | Commercially | Commercially | |
|---|---|---|---|---|---|---|
| | | | available | available | available | |
| | | | product 1 | product 2 | product 3 | Range |
| Hop | Myrcene | % | 18.2 | 60.2 | 157.4 | Less than 146%, |
| components | | | | | | desirably 54.4% or less |
| | Linalool | ppb | 18.7 | 42.2 | 151.4 | 3.8 ppb or more |
| | Nerol | ppb | 0.10 | 0.1 | 0.3 | 0.4 ppb or more, |
| | | | | | | desirably 0.6 ppb or more |
| | Myrcene/ | | 0.9767 | 1.4250 | 1.0396 | 5.2661 or less |
| | Linalool | | 182.2000 | 452.5125 | 524.6333 | 59.7692 or less |
| | Myrcene/ | | | | | |
| | Nerol | | | | | |

As can be seen from Table 12, there were no commercially available products that satisfied the numerical ranges of all the five indicators identified in the above-described Example 5 among the current commercially available alcohol-free beer-taste sparkling beverages. From this test result, the chemical component values also supported that there is no commercially available product that has “an aroma imparted with a fruity aroma derived from a hop or the like with a reduced off-flavor derived from the hop or the like” in the second present invention.

### INDUSTRIAL APPLICABILITY

The present invention can find application in the field of alcohol-free beer-taste sparkling beverages using a hop or a hop component. More specifically, the present invention may suitably include application in the field of alcohol-free beer-taste sparkling beverages imparted with a fruity aroma and a reduced off-flavor and in the field of production method for the aforesaid beer-taste sparkling beverage.

1. A method for producing an alcohol-free beer-taste sparkling beverage imparted with a fruity aroma and a reduced off-flavor, the method comprising the following step (X) or step (Y):
step (X): in a method for producing an alcohol-free beer-taste sparkling beverage using a hop or a hop component, a step of using a hop or a hop component stored and aged being in contact with air, as a hop or a hop component used during a raw material liquid-boiling step:
step (Y): in production of an alcohol-free beer-taste sparkling beverage using a hop or a hop component, a step of adjusting a content of myrcene, linalool, and nerol in the beverage to satisfy the following numerical ranges (a) to (e) of values quantified by GC/MS by boiling the hop or the hop component in a raw material liquid:
(a) when an internal standard substance borneol is added to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration higher than 0.4 ppb, and
(d) a ratio of a value (%) of the ratio in (a) to a value (ppb) of the linalool concentration being 5.2661 or less, and
(e) the ratio of the value (%) of the ratio in (a) to a value (ppb) of the nerol concentration being 59.7692 or less.

2. The method for producing a beer-taste sparkling beverage according to claim 1, wherein the content of myrcene in the hop or the hop component is adjusted to satisfy a range of the following values quantified by GC/MS, by storing and aging of the hop or the hop component used during the raw material liquid-boiling step of the step (X) being in contact with air:
when an internal standard substance naphthalene is added in a hop or hop component sample to reach 2.5 ppm, a ratio of a response value of an ion 93 m/z of myrcene to a response value of an ion 128 m/z of the internal standard substance naphthalene being less than 756.9% in the hop or hop component sample.

3. The method for producing a beer-taste sparkling beverage according to claim 1, wherein a variety of the hop in the hop or the hop component used in the raw material liquid-boiling step of the step (X) is a Motueka, and a storage temperature (° C.) and a storage period (days) in the storage and aging of the hop and the hop component are adjusted to satisfy the following numerical range:
63.616×[storage temperature (° C.)]+115.700×[storage period (days)]>2487.

4. The method for producing a beer-taste sparkling beverage according to claim 2, wherein a boiling time of the hop or the hop component in the step (Y) is within a range of 5 minutes to 20 minutes.

5. The method for producing a beer-taste sparkling beverage according to claim 1, wherein the hop or the hop component is a hop or a hop component of Motueka.

6. An alcohol-free beer-taste sparkling beverage imparted with a fruity aroma and a reduced off-flavor produced by the method for producing a beer-taste sparkling beverage according to claim 1.

7. An alcohol-free beer-taste sparkling beverage imparted with a fruity aroma and a reduced off-flavor, wherein, in the alcohol-free beer-taste sparkling beverage using a hop or a hop component, a content of myrcene, linalool, and nerol in the beverage are prepared to satisfy the following numerical ranges (a) to (e) of values quantified by GC/MS:
(a) when an internal standard substance borneol is added to reach 25 ppb in a beverage sample, a ratio of a response value of an ion 93 m/z of myrcene to a response value of an ion 110 m/z of the internal standard substance borneol in the beverage sample being less than 146.4%, and
(b) a linalool concentration of 3.8 ppb or more, and
(c) a nerol concentration being higher than 0.4 ppb, and
(d) a ratio of a value (%) of the ratio in the (a) to a value (ppb) of the linalool concentration being 5.2661 or less, and
(e) a ratio of the value (%) of the ratio in the (a) to a value (ppb) of the nerol concentration being 59.7692 or less.
